(19) United States
(12) Patent Application Publication
(10) Pub. No.: US 2008/0229652 A1
(43) Pub. Date: Sep. 25, 2008

(54) Insect Trap

(76) Inventors: John Cadman Willcox, Meriden (GB); John Maurice Weaver, Worcestershire (GB)

Correspondence Address: DAVID I. ROCHE;BAKER & MCKENZIE LLP, 130 EAST RANDOLPH DRIVE, CHICAGO, IL, 60601, US

(21) Appl. No.: 11/860,516

(22) Filed: Sep. 24, 2007

(30) Foreign Application Priority Data
Mar. 24, 2007 (GB) 4002128

(51) Int. Cl. A01M 1/04

(52) U.S. Cl. 43/113

(57) ABSTRACT

The embodiments described and claimed herein relate to insect traps. One particular embodiment of the insect trap comprises a housing which holds a insect attracting light source, an insect immobilizing device, and a visible-spectrum light source. The housing at least partially conceals the insect attracting light source, the insect immobilizing device, and the visible-spectrum light source from view and includes a channel into which insects can enter the housing and approach the insect immobilizing device and through which a graduated pattern of insect attracting light can be projected into an area desired to be free from insects. The light pattern emitted from the insect trap includes a diffused light component that is reflected off of a reflective surface and an intense light component that is transmitted through a light conduit. The light conduit captures light from the insect attracting light source from a first end that is in close proximity to the insect attracting light source. A second end of the light conduit is disposed near the opening of the channel and is oriented in such a manner so as to transmit the insect attracting light source into the direction of the area desired to be free from insects.

### CROSS REFERENCE TO RELATED APPLICATIONS

This application claims priority to UK Design Registration No. 4002128, which was filed on Mar. 24, 2007 and is incorporated herein by reference.

### FIELD OF THE INVENTIONS

The embodiments described and claimed herein relate generally to insect traps. More specifically, some of the embodiments described herein relate to insect traps which are disguised as ordinary light fixtures or wall sconces, whereby the insect traps are particularly adapted for use at eating establishments.

### BACKGROUND OF THE INVENTIONS

It is well known in the art to use ultraviolet (“UV”) light as a means for luring the insects into a trap. UV light is one form of electromagnetic radiation that has a wavelength in the approximate range between 100 and 400 nanometers (“nm”). Although the human eye is unable to detect ultraviolet light, some animals can see UV light, including many insects such as bees and flies. UV light is subdivided into three bandwidths: UV-A, UV-B, and UV-C. UV-C is sometimes referred to as extreme ultraviolet and is characterized by wavelengths between 100 and 280 nm. UV-B is sometimes referred to as far ultraviolet and has a wavelength between 280 and 315 nm. UV-A, which is particularly relevant to the present embodiments, is sometimes referred to as near ultraviolet and has a wavelength between 315-400 nm. Light which is often referred to as a “dark light,” “black light,” or “black light blue” are all generating UV-A light.

There are several theories as to why insects are attracted to UV-A light. In their natural state, insects would be foraging, searching for food resources in vegetation which is in shadow and darkness. The way out of this environment is to seek light and in particular UV light as it is an element of sunlight. When insects fly from the interior of vegetation towards open space, they seek a bright light gap, or light intensity graduations. Also, some flowers, fungi, and liquids reflect UV-A light. Insects are believed to associate UV-A light with food sites, mating opportunities, and potential egg laying sites. UV-A is therefore believed to be a key component of insect vision.

It has been observed that a number of factors positively affect the efficacy of light emitting insect traps (i.e., the rate of catch and type of species), including bulb brightness, the size of the UV emitting area, bulb orientation, trap location, flicker frequency, and wavelength. Although it is generally true that traps which incorporate brighter bulbs tend to have a greater catch rate, manufacturers must weigh a number of factors when selecting bulb brightness, such as regulatory limits on radiation exposure. The trap location has a relevance since a competing UV source, such as outside light, can minimize the catch should the unit be placed by a window. Also, the insect trap ideally should be placed where insects typically go; for example, the insect trap preferably should be spaced from the ceiling. It has also been observed that insect attraction increases with increasing light intensity and when there is some background luminosity. In other words, a greater insect response can be had when a UV light pattern is emitted which includes zones of high and low intensity light.

It has further been observed that UV light sources which peak in the range of 345 to 375 nm, and more preferably peak at a wavelength of slightly less than 360 nm, provide optimum insect response. The selection of this optimal wavelength is based upon empirical research on the peak response of various insects. For example, house flies have a UV peak response at 340-350 nm. Honey bees have a UV peak response at 336 nm. Fruit Flies have UV peak response at 345 and 375 nm. Although research continues in the spectral response of different species of insect, it has been extrapolated from the given examples that Dipterans have similar optical resolution capabilities and that UV sources that emit sub 360 nm engenders a greater response in such creatures.

Finally, it has been observed that an increased catch rate may be achieved when UV-A light is directed towards the area desired to be free from insects, rather than at the wall like some prior art devices. It is believed that directing the UV-A light outward, as opposed to directing the UV-A light against the mounting wall surface, better simulates an available exit from dense vegetation. When insects fly from the interior of vegetation towards open space, they do not see a big blanket of UV light, and instead will see light within gaps between leaves that vary in size.

It has been found that prior art devices that utilize UV-A light as a lure have failed to include many of these efficacy increasing features while at the same time providing a device which is well accepted by consumers. Insect traps that utilize UV-A light are often used at eating establishments, where patrons do not want to see an exposed light bulb, much less an insect trap, the thought of which can be unappetizing.

### SUMMARY OF THE INVENTIONS

The embodiments described and claimed herein solve at least some of the shortcomings of the prior art by providing light traps that cloak the insect catching nature of the device. One exemplary embodiment of a light trap utilizes two (UV-A) lamps that are at least partially hidden within the trap, but are configured to project UV light out of two light channels which face forward, away from the wall surface to which the trap is mounted. The two light channels are on the left and right sides of the unit, and can include structures to prevent any display or pattern on the wall with regard to UV light.

The light traps also include two visible light sources, which can be two lamps which will deliver task lighting or an LED output which will deliver a more accent lighting, the application dictating which approach to adopt. In one instance, the visible light sources can be oriented to project light on to the wall. The visible light sources do not emit any UV component and as such do not significantly contribute to the light attraction mechanism. In such a manner, the visible light sources add to the overall assembly in its masquerade as a wall wash illumine. By combining the visible and invisible, insect attracting, light in one device, yet keeping each discreet, the unit can be perceived first and foremost as a wall wash light, thereby permitting the unit to be deployed in sensitive areas.

Light pipes can be fitted within the light channels to display a vertically intense UV lines within the UV radiation loom to manipulate the UV signature of the light trap. Insects sighting the UV irradiation would approach and be attracted towards the source and enter the unit where the intensity of UV is greater. Inside the unit, behind a front panel is a replaceable control board (adhesive covered board) on to which an insect could be entrapped.

Other embodiments, which include some combination of the features discussed above and below and other features which are known in the art, are contemplated as falling within the claims even if such embodiments are not specifically identified and discussed herein.

The ornamental features of the embodiments described and disclosed herein are the subject of U.S. patent application Ser. No. 29/295,239, which was filed on Sep. 24, 2007 and is incorporated herein by reference.

### BRIEF DESCRIPTION OF THE DRAWINGS

These and other features, aspects, objects, and advantages of the embodiments described and claimed herein will become better understood upon consideration of the following detailed description, appended claims, and accompanying drawings where:

FIG. 1 is a perspective view of a first embodiment of a light trap;

FIG. 2 is a front view thereof;

FIG. 3 is a side view thereof;

FIG. 4 is a bottom view thereof, the top view being essentially a mirror image thereof;

FIG. 5 is an exploded view thereof,

FIG. 6 is a sectional view thereof which includes a visual representation of the radiation loom emitted from the light channels;

FIG. 7 is a front view thereof which also includes a visual representation of the radiation loom emitted from the light channels;

FIG. 8 is aside view thereof which also includes a visual representation of the radiation loom emitted from the light channels;

FIG. 9 is a perspective view of a second embodiment of a light trap with its front cover in the open position;

FIG. 10 is a close-up perspective view thereof which demonstrates how the light pipes are installed into the trap; and,

FIG. 11 is a perspective view of a third embodiment of a light trap.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

Like reference numerals will be used to refer to like or similar parts from Figure to Figure in the following detailed description of the drawings.

### DETAILED DESCRIPTION OF THE DRAWINGS

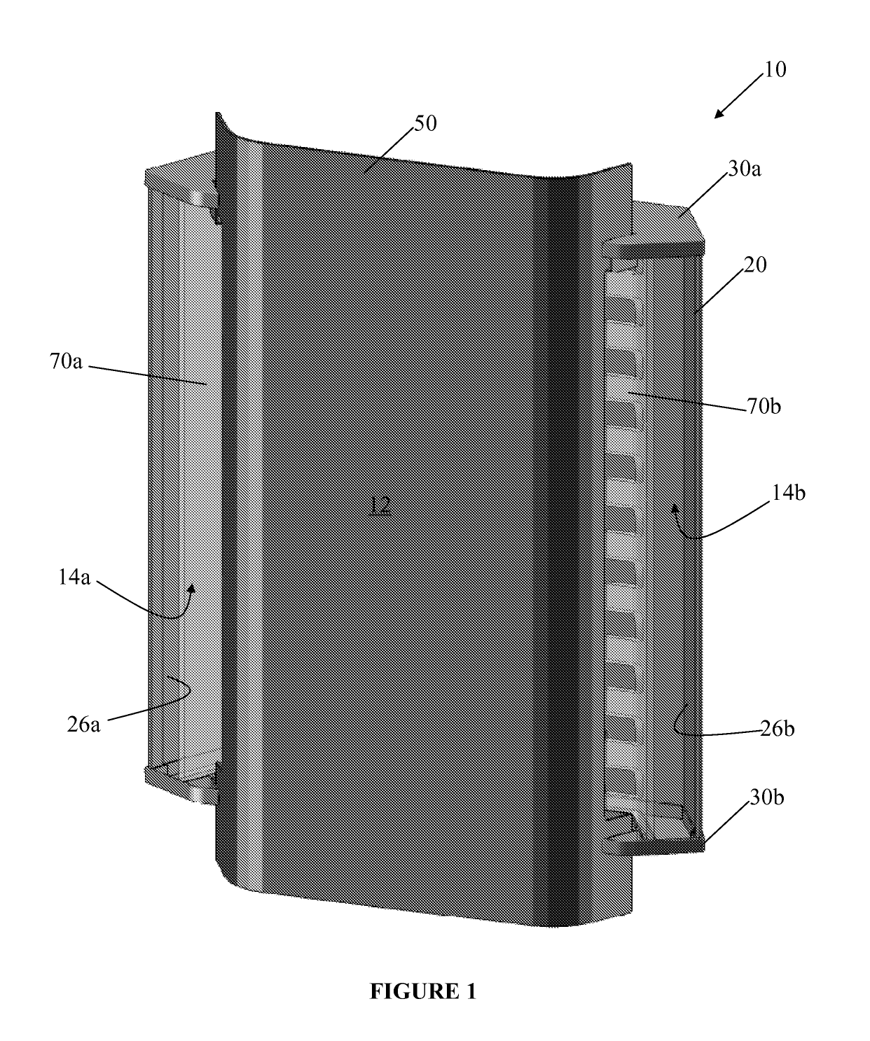

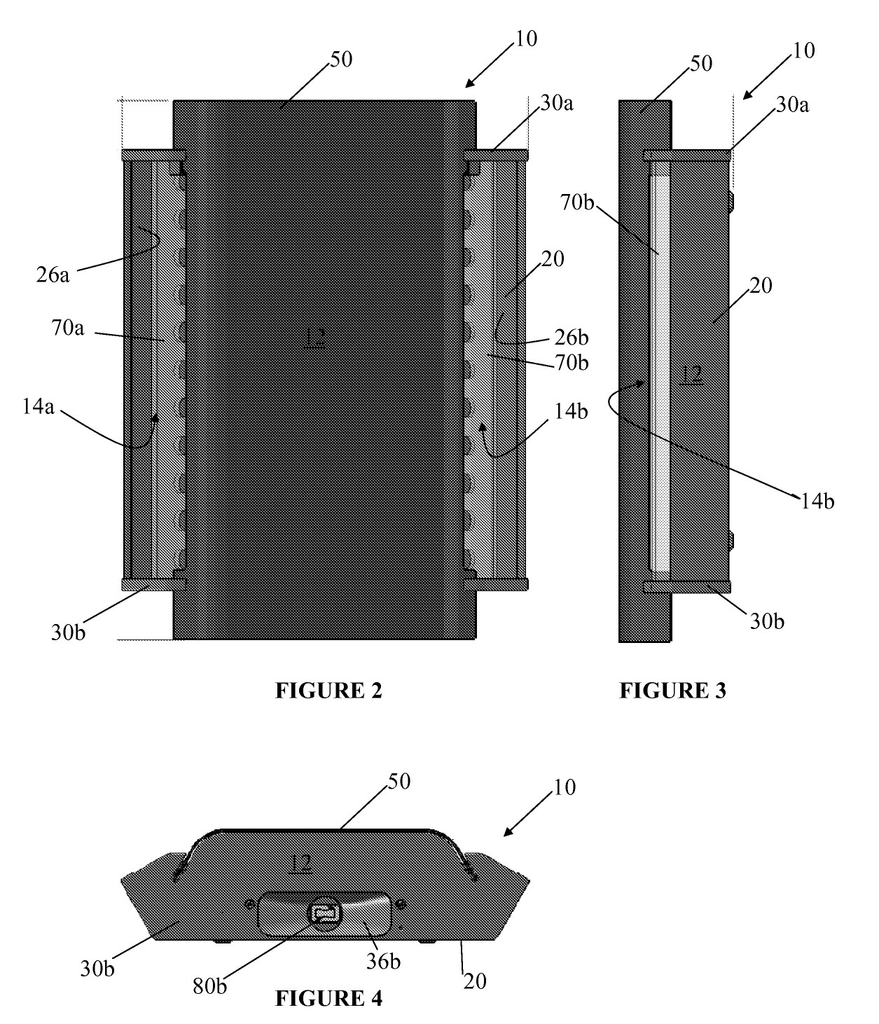

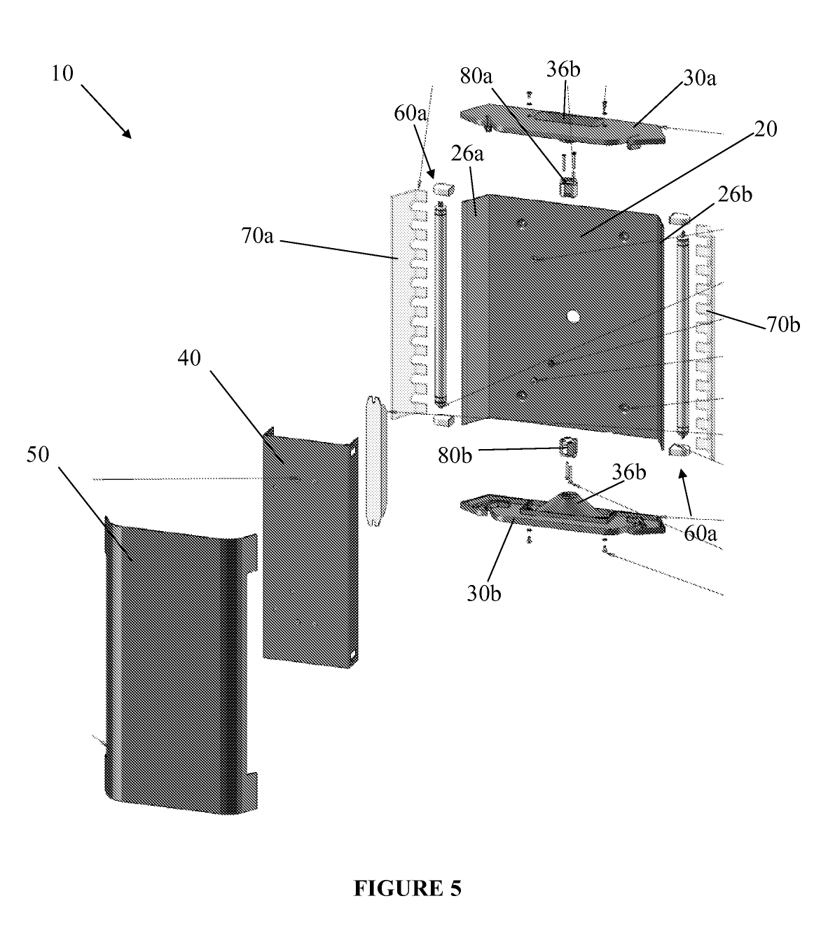

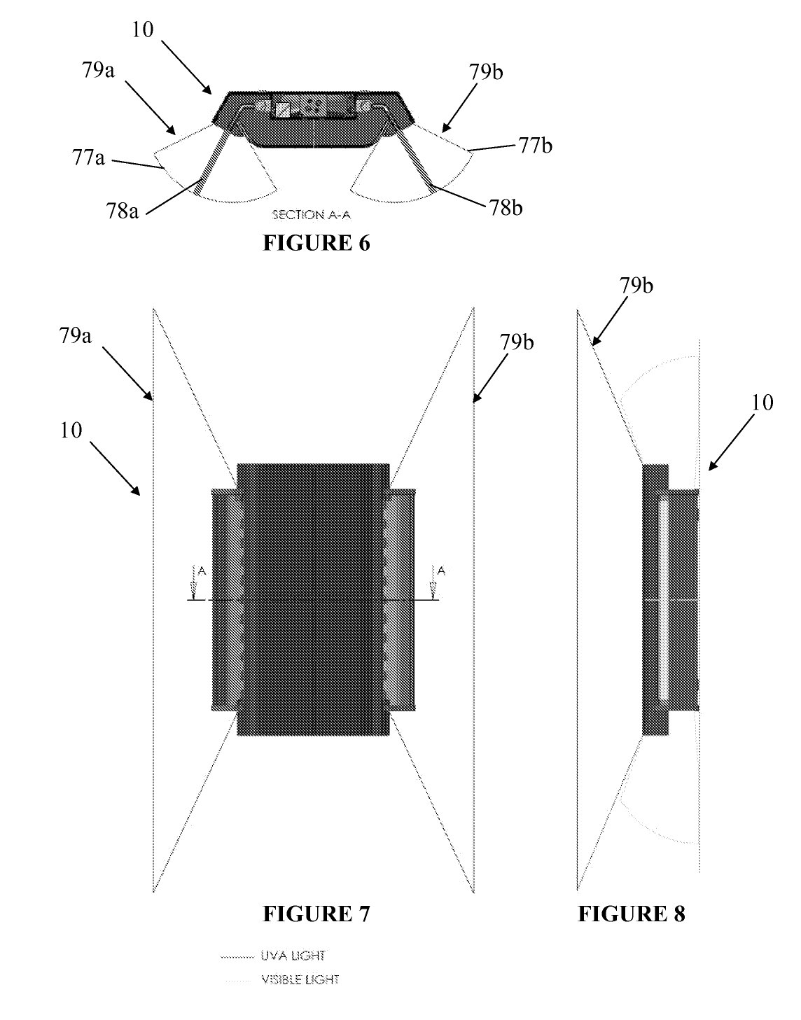

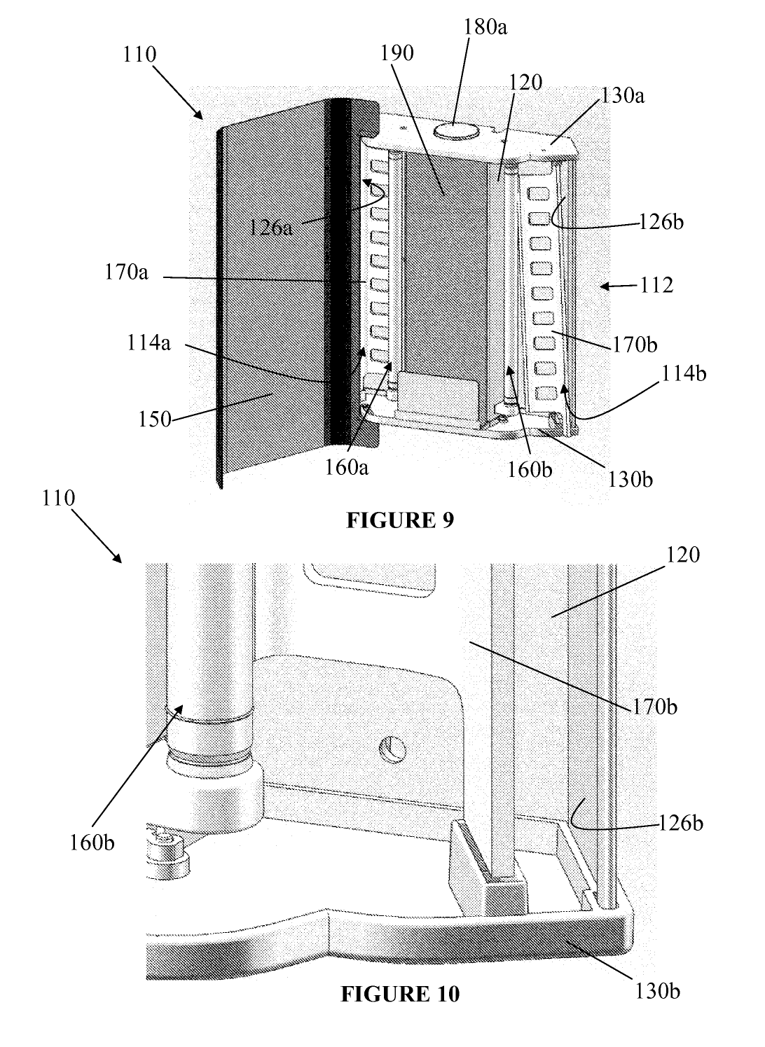

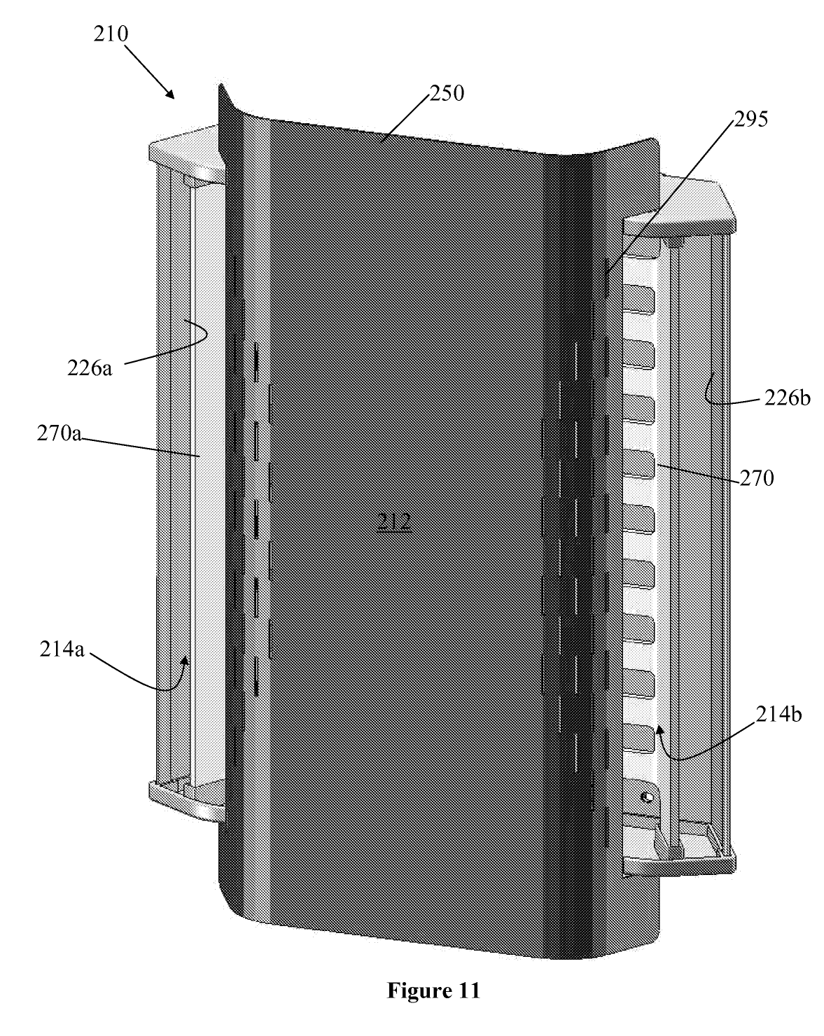

Three particular embodiments of a light trap 10, 110, 210 are described and shown herein, the first in FIGS. 1-8, the second in FIGS. 9-10, and the third in FIG. 11. Each of these embodiments are configured for installation on a wall surface, although it is contemplated that devices which utilize the claimed features could be adapted for mounting on other surfaces. The light traps 10, 110, 210 are designed to present a neutral aesthetic, as compared to current light traps, by substantially hiding from view, within the light traps 10, 110, 210 two insect attracting light sources 60a, 60b, 160a, 160b (not shown for third embodiment) and an insect immobilizing device 190 (not shown for first and third embodiment). Although the shown embodiments each utilize two insect attracting light sources 60a, 60b, 160a, 160b, it is contemplated that more or less could be utilized with satisfactory results. Contributing to the neutral aesthetic of the trap 10, 110, 210, the insect attracting light sources 60a, 60b, 160a, 160b are maintained substantially outside of a typical bystander's line of sight, except when the light trap 10, 110, 210 is viewed from extreme angles. By concealing the light sources 60a, 60b, 160a, 160b within the light trap, however, insect attracting light is prevented from directly projecting forward from the light trap. To enable the insect attracting light to reach the exterior of the light traps 10, 110, 210 and project in a forward (away from the wall surface) direction, the light traps 10, 110, 210 include structures for channeling light into the desired direction, which is usually the area desired to be free of insects. Further contributing to the neutral aesthetic, the light traps 10, 110, 210 have the capability to project visible-spectrum lighting on the wall. In that respect, the three embodiments 10, 110, 210 described and shown herein are insect traps which are disguised as standard wall wash light fixtures.

The three embodiments of the light trap 10, 110, 210 are substantially similar, but include slight differences in structure and in assembly, as described in more detail below. The light traps 10, 110, 210 are similar in the respect that they are all adapted to project insect attracting light into the area desired to be free of insects. They all utilize two insect attracting light sources 60a, 60b, 160a, 160b that emit ultraviolet (or UV) light, and specifically ultraviolet light of the A bandwidth (referred to herein as “UV-A” light). Although UV-A light is not visible to the naked human eye, insects are able to see and are particularly attracted to UV-A light, as discussed in more detail above. Satisfactory results can be obtained with a light source that emits light within the full spectrum of the UV-A bandwidth (i.e., between approximately 315 nm and 400 nm). However, it has been found for most insect species that better results can be obtained using an insect attracting light that emits UV-A light having a predominant wavelength between 345 to 375, and ideally slightly less than 360 nm. To satisfy this criteria, black light blue lamps sold under the trade name Vector, which emit peak UV light at 353 nm, can be used.

In the three embodiments 10, 110, 210 the insect attracting light sources 60a, 60b, 160a, 160b are positioned within light housings 12, 112, 212 behind the front cover 50, 150, 250 of the housing. The front cover 50 prevents the insect attracting light source from directly emitting light in a direction normal to the wall surface and within approximately 30-40 degrees on either side of normal. Since the insect attracting light sources 60a, 60b, 160a, 160b are generally shielded from view, the light traps 10, 110, 210 utilize light channels 14a, 14b, 114a, 114b, 214a, 214b and light pipes 70a, 70b, 270a, 270b to direct insect-attracting light outwardly from the light trap 10, 110 and away from the wall structure to which the traps 10, 110 are mounted.

The light channels 14a, 14b, 114a, 114b, 214a, 214b are oblong in shape, are generally vertically oriented, and have and combined area of approximately [50 in² or 0.032 m²], although it is contemplated that devices having light channels of various other shape and orientation will fall within the scope of the claims. The light channels 14a, 14b, 114a, 114b, 214a, 214b include reflective surfaces 26a, 26b, 126a, 126b, 226a, 226b to effectively reflect light outwardly from the light trap 10, 110, 210. Due to the concealed nature of the insect attracting light sources 60a, 60b, 160a, 160b, emitted insect attracting light extends laterally from the sources 60a, 60b, 160a, 160b, in a direction generally parallel to the wall surface, toward the reflective surfaces 26a, 26b, 126a, 126b, 226a, 226b. The reflective surfaces 26a, 26b, 126a, 126b, 226a, 226b are oriented at an angle of approximately 120 degrees from the wall structure to thereby reflect the insect attracting light into the area desired to be free from insects. The reflective surfaces 26a, 26b, 126a, 126b, 226a, 226b can also serve as shields for blocking the transmission of insect attracting light onto the wall surface to which the light trap 10, 110, 210 is attached. Alternatively, the light trap could include separate shields to perform such a function.

The light pipes or conduits 70a, 70b, 170a, 170b, 270a, 270b provide a second means for channel light in the desired direction by effectively “bending” concentrated, insect-attracting light through the opening of the light channels 14a, 14b, 114a, 114b, 214a, 214b. In the shown embodiments, the light conduits 70a, 70b, 170a, 170b, 270a, 270b are acrylic plate-like structures, although it is contemplated that other materials, such as glass, and other light conduit(s), including fiber-optic like devices, could be used in a similarly effective manner. The light conduits 70a, 70b, 170a, 170b, 270a, 270b at a first end abut the insect attracting light source 60a, 60b, 160a, 160b to capture concentrated insect attracting light. Light is transmitted through the light conduit 70a, 70b, 170a, 170b, 270a, 270b and is emitted from the second, opposing end of the light conduit 70a, 70b, 170a, 170b, 270a, 270b, which is disposed near the opening of the light channel 14a, 14b, 114a, 114b, 214a, 214b. In the shown embodiments, the lengthwise dimension of the light conduit 70a, 70b, 170a, 170b, 27a, 270b is oriented generally parallel with the lengthwise dimension of the light channels 14a, 14b, 114a, 114b, 214a, 214b, although alternative embodiments are contemplated where the conduits are oriented in various other direction. Due to the light conduit's plate like structure, the light projected from the conduit is characterized by an intense line of insect attracting light. However, other patterns are contemplated depending upon the specific type of light conduit that is utilized.

In use, the insect attracting light that is reflected off of the reflective surfaces 26a, 26b, 126a, 126b, 226a, 226b tends to leave the light channels in a diffused pattern 77a, 77b, while the insect attracting light that is transmitted through the light conduits is much more intense and is emitted from the light channels in a much more concentrated pattern 78a, 78b. The diffused and concentrated patterns of light which are emitted from the light channels merge to form a light pattern 79a, 79b having intensity graduations. The patterns of light emitted by the light channels 14a, 14b, 114a, 114b, 214a, 214b and associated structures are depicted in FIGS. 7-9.

With specific reference now to FIGS. 1-8, the first embodiment of the light trap 10 is shown. The light trap 10 generally comprises a light housing 12 which is configured to be mounted to a wall structure and to support various other components of the light trap 10. The shown embodiment of the light housing 12 is constructed of several components to define openings for the light channels 14a, 14b. Such components include a rear panel 20, two end panels (or mouldings) 30a, 30b, an internal chassis plate 40, a front cover 50, and an electronic ballast 42. The electronic ballast 42 is choke which regulates the current when the UV lamp is running.

The second embodiment of the light trap 110, as shown in FIGS. 9-10, also includes a light housing 112 which is constructed of several components. Such components include a rear panel 120, two end panels 130a, 130b, and a front cover. As may not be clearly shown in the figures, the second embodiment does not utilize an internal chassis plate, since such structure is integrated with the rear panel 120.

The third embodiment of the light trap 210, as shown in FIG. 11, is nearly identical to the second embodiment 110, except with respect to the front cover 250.

In all embodiments shown described herein, the rear panel 20 has a center portion and two bent wing portions on the left and right side therefore, which extend at an angle to the center portion. It is contemplated that the rear panel 20 is fabricated from a metal material, such as Aluminum whereby the inside surface of the bent wing portions serve as the reflective surfaces 26a, 26b for the light channels 14a, 14b. It is also contemplated; however, the rear panel 20 could be fabricated from some other material, even a material such as plastic, which may not be sufficiently reflective. In such cases, an additional reflective structure may be provided in the light channel 14a, 14b, such as a metallic-like sticker which is adhered to the inside surface of the rear panel 20. As far as structure is concerned, the rear panel is provided with several apertures to enable the light trap 10 to be mounted to a wall surface, to provide a cable outlet, and to allow the electronic ballast 42 to be mounted thereto. Although the embodiments shown and described herein are intended to be wall-mounted, the light trap could be free standing, could be mounted to some sort of stand or pole, or could be mounted in any other manner.

Attached to opposing sides of the chassis plate 40 of the first embodiment, and the chassis region of the rear panel 120 of the second embodiment, are the insect attracting light sources 60a, 60b, 160a, 160b. Although not depicted in the figures, the wiring and related components for powering the insect attracting light sources and visible-spectrum light sources are enclosed behind the chassis plate 40 of the first embodiment and the chassis region of the rear panel 120 of the second embodiment.

Each of the end panels 30a, 30b, 130a, 130b include a plurality of slots or the like for receiving and/or engaging with opposing ends of the rear panel 20, 120 and internal chassis plate 40. For the end panels 30a, 30b of the first embodiment, a first slot is provided along a rear edge of each end panel for receiving the rear panel 20 and a second slot, which has the same general contour as the chassis plate 40, is provided extending from a rear edge of each end panel 30a, 30b for receiving the chassis plate 40. Each of the end panels 30a, 30b are provided with an additional pair of slots which are configured to receive the light conduits 70a, 70b. The end panels 30a, 30b also include slots which are configured to engage with the front cover 50. For such purpose, the bottom end panel 30b includes two inwardly-diverging, open-bottomed slots which are configured for sliding engagement with the front cover. The top end panel 30a includes two inwardly-diverging, closed-bottom slots which are also configured for sliding engagement with the front cover. However, the closed-bottom of the slot in the top end panel 30a engages with the cover to hold the cover in place. The control board (not shown) is intended to be tucked in at the transition of the end panels 30a, 30b and chassis plate 40.

For the end panels 130a, 130b of the second embodiment, a first slot is provided for receiving the rear panel 120. The top end panel 130a includes a second, elongated slot which is configured to receive a first end of the control board. The bottom end panel 130b includes a lip which is adapted to engage with the opposed end of the control board, which on a standard control board (such as the one sold by Brandenburg with product number BBG1012.5) is a folded over portion. Each of the end panels 130a, 130b also include a pair of slots which are configured to engage with the end portions of the light conduits 170a, 170b. The light conduits 170a, 170b have a length which is less than the length between the two end panels 130a, 130b whereby the conduits can be angled into the conduit supporting slots as depicted in FIGS. 9-10. The ends panels 130a, 130b also include apertures which serve as hinges for the front cover 150, which is adapted to pivot between open and closed positions.

To hold the light housing 12 together, fasteners engage with the chassis plate 40 of the first embodiment, or the rear panel 120 through apertures which are provided on the end panels 30a, 30b, 130a, 130b.

Both embodiments of the end panels 30a, 30b, 130a, 130b include generally conically or concave shaped, recessed portions 36a, 36b (not depicted in the Figures for the second and third embodiments) into which a visible spectrum light source can be attached. In one particular embodiment, the visible spectrum light source is an LED GU10 light bulb.

The structure of the three embodiments of the light conduits 70a, 70b, 170a, 170b, 270a, 270b are substantially similar although the first embodiment abuts the insect attracting light source 60a, 60b from the side while the second and third embodiments abut the insect attracting light source 160a, 160b from the rear. To facilitate such configuration, the conduits 70a, 70b, 170a, 170b, 270a, 270b have lengths that extend in more than one dimension, whereby the first embodiment 70a, 70b includes one bend along its length, while the second and third embodiments 170a, 170b, 270a, 270b include two bends.

The front covers 50, 150, 250 are substantially similar, although, as discussed above, the first embodiment is configured for sliding engagement with the end panels 30a, 30b, while the second and third embodiments are configured for pivoting engagement with the end panels 130a, 130b. The front panels 50, 150, 250 extend in a lateral dimension a sufficient distance to shield the insect attracting light sources 60a, 60b, 160a, 160b from any light of sight extending normal to the light fixture and within 30-40° to either side thereof. The front covers 50, 150, 250 also extend a distance upwardly and downwardly of the end panels 30a, 30b, 130a, 130b to shield the wall wash light elements 80a, 80b, 180a, 180b from view.

The front cover 250 of the third embodiment, as shown in FIG. 11, includes a plurality of windows 295 which provide an additional escape of UV light from the light trap 250. Although the shown embodiment utilizes a plurality of windows 295, any number can be used. The windows 295 are disposed in two separate groupings, one on the right side of the light trap and the other on the left side of the light trap. Each grouping of windows 295 is arranged in a triangular pattern, although any pattern can be used. Each window 295 is generally rectangular, although it is contemplated that the windows 295 can have any shape. In the shown embodiment, the windows 295 are translucent or screened to mask what is inside of the light trap (the UV lamps and insect immobilizer), although the windows 295 can be clear. Any material can be used for the windows, including glass and plastics (such as acrylic).

To provide the windows 295 with a translucent appearance, the inside surface of the windows could be a roughened surface, similar to the cover housing as disclosed in U.S. Pat. No. 6,108,965, which is incorporated by reference. As used herein, the term “roughened surface” means a surface that is broken, uneven, textured, bumpy or otherwise does not have a smooth profile. Such a surface may be formed by sandblasting or molding the windows 295 using a mold with a textured surface. It is believed that by providing the windows 295 with a roughened inner surface which is in facing relationship with the UV lamps, the transmission of insect attracting light from the UV lamps through the front cover 50 can be enhanced. While not wanting to be bound by theory, it is believed that the roughened surface acts as a magnifier of the light from the light source.

Although the inventions described and claimed herein have been described in considerable detail with reference to certain embodiments, one skilled in the art will appreciate that the inventions described and claimed herein can be practiced by other than those embodiments, which have been presented for purposes of illustration and not of limitation. Indeed, it is contemplated, that the light trap can take many different shapes, orientations, and forms, besides those described and shown herein. Therefore, the spirit and scope of the appended claims should not be limited to the description of the embodiments contained herein.

We claim:

1. An apparatus for trapping insects comprising:
at least one insect attracting light source that emits insect attracting light;
at least one insect immobilizing device which is configured to immobilize insects;
at least one visible-spectrum light source that emits light which is visible to the human eye;
a housing holding the insect attracting light source, the insect immobilizing device, and the visible-spectrum light source and being configured for mounting on a surface;
the housing at least partially enclosing the insect attracting light source and the insect immobilizing device to at least partially conceal the insect attracting light source and insect immobilizing device from view; and,
the housing having an opening into which insects can enter the housing and approach the insect immobilizing device and through which the insect attracting light is projected out of the housing and into the general direction of an area desired to be free from insects.

2. The apparatus of claim 1, wherein the housing further includes a plurality of windows through which insect attracting light is emitted into the direction desired to be free from insects.

3. The apparatus of claim 2, wherein the plurality of windows are translucent.

4. The apparatus of claim 1, wherein the apparatus further comprises a reflective surface for reflecting the insect attracting light through the opening and at least in a direction normal to the surface, but which prevents the insect attracting light from being projected onto the surface.

5. The apparatus of claim 1, wherein the apparatus further comprises a light conduit having a first end in close proximity to the insect attracting light source to capture insect attracting light that is emitted there from and having a second end disposed near the opening to project intense insect attracting light toward the area desired to be free from insects.

6. The apparatus of claim 5, wherein the light conduit has a length that extends in at least two directions to effectively bend the insect attracting light into a desired direction.

7. The apparatus of claim 6, wherein the light conduit is fabricated from an acrylic material.

8. The apparatus of claim 6, wherein the light conduit is a plate-like structure and the second end of the light conduit is elongated in shape whereby the light conduit projects an intense line of insect attracting light into the area desired to be free of insects.

9. The apparatus of claim 8, wherein the light conduit divides the opening into two separate chambers and includes a plurality of apertures to allow insects to traverse from one chamber to the other.

10. The apparatus of claim 1, wherein the insect attracting light includes a light component within the UV-A spectrum.

11. The apparatus of claim 10, wherein a substantial component of the insect attracting light has a wavelength of between 345 and 375 nm to ellicit an increased insect response.

12. The apparatus of claim 1, wherein the insect immobilizing device is a retaining surface onto which an insect could be entrapped.

13. The apparatus of claim 1, wherein the visible-spectrum light source does not emit light which is within the UV-A spectrum.

14. The apparatus of claim 1, wherein the visible-spectrum light source is oriented to project light onto the surface.

15. An apparatus for trapping insects comprising:
at least one insect attracting light source that emits insect attracting light;
at least one insect immobilizing device which is configured to immobilize insects;
a housing holding the insect attracting light source and the insect immobilizing device and being configured for mounting on a surface;
the housing at least partially enclosing the insect immobilizing device to substantially conceal the insect immobilizing device from view;
the housing having an opening into which insects can enter the housing and approach the insect immobilizing device and through which the insect attracting light is projected out of the housing and into the general direction of an area desired to be free from insects; and;
a light conduit having a first end in close proximity to the insect attracting light source to capture insect attracting light that is emitted there from and having a second end disposed near the opening to project intense insect attracting light away from the surface and toward the area desired to be free from insects.

16. The apparatus of claim 15, wherein the housing further holds at least one visible-spectrum light source that emits light which is visible to the human eye, the visible-spectrum light source being oriented to project light onto the surface.

17. The apparatus of claim 15, wherein the apparatus further comprises a reflective surface for reflecting the insect attracting light through the opening in a diffused pattern, but which prevents the insect attracting light from being projected onto the surface.

18. The apparatus of claim 17, wherein the light conduit is a plate-like structure and the second end of the light conduit is elongated in shape whereby the light conduit projects an intense line of insect attracting light within the diffused pattern of light that is projected by the reflective surface, whereby significant intensity graduations are present in the insect attracting light that is project from the opening in the housing.

19. The apparatus of claim 18, wherein the light conduit has a length that extends in at least two directions to effectively bend the insect attracting light into a desired direction.

20. The apparatus of claim 18, wherein the light conduit is fabricated from an acrylic material.

21. An apparatus for trapping insects comprising:
at least one insect attracting light source that emits insect attracting light;
at least one insect immobilizing device which is configured to immobilize insects;
at least one visible-spectrum light source that emits light which is visible to the human eye;
a housing holding the insect attracting light source, the insect immobilizing device, and the visible-spectrum light source and being configured for mounting on a surface;
the housing at least partially concealing the insect attracting light source, the insect immobilizing device, and the visible-spectrum light source from view;
the housing having an opening into which insects can enter the housing and approach the insect immobilizing device and through which a varying pattern of insect attracting light is projected;
the varying pattern of insect attracting light including a diffused light component that is reflected off of a reflective surface; and,
the varying pattern of insect attracting light further including an intense light component that is transmitted through a light conduit which has a first end in close proximity to the insect attracting light source to capture insect attracting light that is emitted there from and a second end disposed near the opening.

22. The apparatus of claim 21, wherein the housing further includes a plurality of windows through which insect attracting light is emitted and contributes to the varying pattern of insect attracting light.

23. The apparatus of claim 22, wherein the plurality of windows are translucent.

24. The apparatus of claim 21, wherein the insect attracting light includes a light component within the UV-A spectrum.

25. The apparatus of claim 22, wherein the insect immobilizing device is an adhesive covered board onto which an insect could be entrapped.

26. The apparatus of claim 25, wherein the visible-spectrum light source does not emit light which is within the UV-A spectrum.

27. The apparatus of claim 26, wherein the visible-spectrum light source is oriented to project light onto the surface.

28. The apparatus of claim 21, wherein the graduated pattern of insect attracting light is projected into the general direction of an area desired to be free from insects and wherein the housing includes a shield to prevent light from being projected onto the surface.

29. The apparatus of claim 28, wherein the light conduit has a length that extends in at least two directions to effectively bend the insect attracting light into a desired direction.

30. The apparatus of claim 29, wherein the light conduit is fabricated from an acrylic material.

31. The apparatus of claim 30, wherein the light conduit is a plate-like structure and the second end of the light conduit is elongated in shape whereby the light conduit projects an intense line of insect attracting light into the area desired to be free of insects.

32. The apparatus of claim 31, wherein the light conduit divides the opening into two separate chambers and includes a plurality of apertures to allow insects to traverse from one chamber to the other.

33. An apparatus for trapping insects comprising:
at least one insect attracting light source that emits insect attracting light;
at least one insect immobilizing device which is configured to immobilize insects;
a housing holding the insect attracting light source and the insect immobilizing device and being configured for mounting on a surface;
the housing at least partially enclosing the insect immobilizing device to substantially conceal the insect immobilizing device from view;
the housing having an opening into which insects can enter the housing and approach the insect immobilizing device, the opening providing a first avenue through which the insect attracting light is projected out of the housing and into the general direction of an area desired to be free from insects; and;
the housing having at least one translucent window providing a second avenue through which the insect attracting light is projected out of the housing and into the general direction of an area desired to be free from insects.
